(19) United States
(12) Patent Application Publication
(10) Pub. No.: US 2015/0157030 A1
(43) Pub. Date: Jun. 11, 2015

(54) DOOR FOR A VACUUM COOLING DEVICE

(71) Applicants: Ulrich GIGER, Bubikon (CH); Florian Bäbler, Mollis (CH); Kaspar Bäbler, Mollis (CH)

(72) Inventors: Ulrich GIGER, Bubikon (CH); Florian Bäbler, Mollis (CH); Kaspar Bäbler, Mollis (CH)

(21) Appl. No.: 14/559,799

(22) Filed: Dec. 3, 2014

(30) Foreign Application Priority Data
Dec. 5, 2013 (EP) 13195852.2

(51) Int. Cl. A21D 15/02; F25D 23/02

(52) U.S. Cl. CPC A21D 15/02; F25D 23/021; F25D 23/028

(57) ABSTRACT

A vacuum cooling device (1) for cooling of foodstuff in particular hot bakery products comprises a vacuum chamber (2) which is configured for receiving the foodstuff for its cooling, whereby the vacuum chamber is closeable by a sliding door (20) The sliding door is movable substantially in horizontal direction and the sliding door (20, 126) or the door flange (28) contains a seal (29, 100, 127), which enables a fluid tight sealing in the closed state of the door of the vacuum chamber against the surroundings.

The invention relates to a door for a vacuum cooling device for foodstuffs in particular bakery products. The invention relates in particular to a vacuum cooling device, which is closable by sliding door. The vacuum cooling device for cooling foodstuff in particular bakery products for example freshly baked bread under negative pressure comprises a vacuum chamber which is configured for receiving the fresh bakery product for its cooling.

Hot and humid foodstuff can efficiently be cooled by evacuating them in a vacuum chamber, whereby only a short cooling time is required.

Pivotable doors are commonly used in the prior art to grant access to the vacuum chamber for instance for charge or discharge of the bakery product or for closing the vacuum chamber fluid-tightly in the operating state. Such pivotable doors are commonly attached by articulations arranged on the wall of the vacuum cooling device and are opened or closed manually. An example for such a pivotable door which is pivotable about a vertical axis by means of a hinge is shown in JP 11264641. A door lock can be used. The use of pivotable doors has a number of disadvantages when operating a vacuum cooling plant. The door seals of the pivotable doors are churned (that means engaged under pressure and thereby squeezed) which may lead to damage to the seal material under the high mechanical load.

Leaking door seals result in quality losses of the foodstuff, as the set pressure curves according to the recipes can't be reached due to the fact that it can't be guaranteed, that the sub-atmospheric pressure foreseen is actually reached and can be maintained during the period foreseen in the recipe. The height of the pivotable doors is only marginally lower than the height of the vacuum chamber such that the vacuum chamber can be charged in a single processing step with all racks. Accordingly the pivotable doors have a considerable weight. A considerable amount of space is required for performing the pivoting movement. A pivotable door can have a width of up to 2.5 m and a height of up to 3 m. Thus for this pivotable door a pivot radius of 2.5 m respectively up to 3 m is required.

Due to their weight such doors may be dangerous in their operation. Such a pivotable door may in particular close unexpectedly and lock a coworker inside the chamber.

During the vacuum process vapor condenses on the inside of the pivotable door, the condensate leaves the chamber when opening the pivotable door over the charge and discharge ramp. It also arrives below the vacuum chamber and on the floor, which supports the vacuum chamber. This condensate can contain traces of the foodstuff such that the discharge of the condensate can lead to an unhygienic state if the condensate is not removed immediately by the cleaning step. The humidity and any residues of the baking products present on the charge and discharge ramp increase the slip hazard, whereby the danger for injuries is enhanced for coworkers who have to charge or discharge the vacuum chamber or are present to execute other tasks in the vacuum chamber within the pivoting radius of the pivotable door.

Furthermore it is known from the document CN203145682U a horizontally movable sliding door for a vacuum cooler. This door has a frame the door leaf two hooks a drive and a pneumatical pressing device. The drive is configured as a Linda drive with the linear motor by which the door frame is movable horizontally from closed position to an open position or reverse. The door leaf is pivotable about a horizontal axis which runs along the lower inner edge of the frame. The door leaf is held in the inclined position by the hooks which are connected to the frame if the vacuum chamber is closed. In case of the vacuum chamber is to be opened the lower edge of the door is moved by a pneumatically operated device into the direction of the vacuum chamber whereby the pivoting movement is reversed such that the door leaf is repositioned into a substantially vertical position. If the door leave is in its vertical position the door frame as well as the door can be moved by the linear drive from the closed position into the open position or reverse. According to the drawing the door leaf rests at least partially on the frame of the opening of the vacuum chamber. If the seal was provided on the door leaf or the frame the door seal would be subjected to shear forces during each opening or closing movement. In this document there is no hint to any such seal. The arrangement of the document CN203145682U is not suitable for a vacuum chamber which is disposed with the seal which runs on the door leaf or the frame of the vacuum chamber and which allows for sealing off the vacuum chamber to generate a vacuum.

The document W02010074723 A1 shows a sliding door for a freeze dryer which is movable in vertical direction. The document EP1314521 A1 shows also a sliding door movable in vertical direction for a dryer for ceramic tiles.

The underlying problem to be solved by this invention is to develop a vacuum cooling device with a door whereby the door seal is not subject to churning during opening or closing thereof. Furthermore a vacuum cooling device is to be developed for which the sources of danger for coworkers who remain inside the vacuum cooling device or in the immediate surroundings can be eliminated or at least reduced. Prerequisite for a reproducible quality of foodstuff is a tightly sealable door therefore it is an object of the invention to increase the lifetime of the door seal. The door mechanism should require a minimal space and should be at least partially automated.

This object is solved by the vacuum cooling device according to claim 1. Further advantageous embodiments are subject of the dependent claims 2 to 12. A method for operation of the sliding door for a vacuum cooling device is subject of claims 13, 14 and 15.

A vacuum cooling device for the cooling of foodstuff in particular hot bakery products comprises a vacuum chamber which is configured for receiving the foodstuff for its cooling, whereby the vacuum chamber is closeable by a sliding door. The door is configured as a sliding door in particular with a defined lift with respect to the seal surface. The sliding door is detached with respect to the seal surface according to an embodiment and is subsequently displaced parallel to the vacuum chamber.

In the closed state the sliding door rests upon a door flange. As soon as the sliding door has reached the closed position the sliding door is pressed by an actuator or manually towards the seal surface. The sliding door or the door flange can contain a seal, which enables a fluid tight sealing of the vacuum chamber in the closed state of the door. The seal can in particular be configured as a circumferential seal.

The sliding door is pressed on its own against the seal surface when the vacuum increases thus the inner pressure decreases. After aerating the vacuum chamber the door is lifted with or without spring force from the seal surface. The seal surface is therefore only subjected to a pressure force if the vacuum applies. For this reason the sliding door can comprise a carrier whereby the carrier is guided slidingly in a guide rail. In particular the carrier can be disposed with rollers which are movable along the guide rail along a horizontal path. The sliding door can comprise an opening or closing mechanism. The sliding door can be moved by operation of the closing mechanism such that the seal comes to lie onto the door flange whereby a seal effect is obtained. In particular the seal rests on the door flange uniformly everywhere. Thus the seal is free from churning that means that no shear forces are transmitted from the sliding door to the seal if the seal is attached to the door flange respectively no shear forces are transmitted from the door flange to the sliding door if the seal is attached to the sliding door. The carrier can comprise a compensation element. The seal can be assembled and dismounted in a simple manner to be exchanged or cleaned. For example the seal can be submerged temporarily in a cleaning solution. After completion of the cleaning step, the seal can be mounted again in the door flange, on the inner side of the sliding door or around the circumference of the door leaf.

According to an embodiment the sliding door can comprise a reinforcing element to support a frame which forms a door flange. Thereby a deformation of the sliding door in particular the door leaf of the sliding door can be avoided. The sliding door can rest uniformly on the frame forming the door flange or the door frame. Thereby the seal is subjected to a pressure in a uniform manner over the entire circumference.

In particular the vacuum cooling device according to any of the preceding embodiments can be disposed with a sliding door which has a door leaf which rests at least along the seal surface on the door flange. The door leaf can comprise a plate like surface which can close the vacuum chamber fluid tightly. The seal can comprise a compensation element to seal even if the door leaf and/or the door flange comprise an unevenness. By means of the compensation element a uniform support of the seal on the corresponding base, that means the door leaf or the door flange, can be obtained.

A condensate collection container is arranged below the sliding door to discharge all condensate into the condensate collection container. The condensate collection container can have a width which is corresponding to the sliding distance of the sliding door. The condensate obtained during operation can drop directly into the condensate collection container when the door is opened. The condensate is mostly condensed water. The condensate collection container has a bottom surface which is at least a bit inclined with respect to the horizontal plane to allow for simple flow off of the condensate. A drain is arranged in the lowermost point off the bottom surface. The drain is directed directly to the sewage water system. If the sliding door is to be used the vacuum chamber is lifted by support feet. Thereby the foodstuff containers are charged and discharged automatically which increases personal safety notably.

The advantage of the invention relies primarily in the fact that the seal of the sliding door has a higher lifetime and can be used over a longer period. The process quality and reproducibility are increased. The required space for the vacuum chamber including the sliding door is smaller due to the fact that the pivoting area is not needed for sliding door. The opening and closing of the sliding door of the vacuum chamber is easily automated.

Due to the fact that less space is required for the sliding door two opposite sliding doors can be used for a vacuum chamber. The use of two sliding doors makes it possible to use the vacuum chamber as a gating, for instance between the bakery and the clean room. Such a clean room can be foreseen for instance for the packaging of the vacuum cooled foodstuff. The bakery environment contains flour in on the air which should not reach the clean room.

Thus according to an embodiment a first and a second sliding door can be foreseen. The first sliding door and the second sliding door can be used alternatively such that the bakery product to be cooled can be moved through the vacuum chamber only in one single direction. The first and second sliding door can also be used as the gated path to separate the production area for the bakery products from the storage area of the finished bakery products.

By arranging the condensate collection container below the sliding door all condensate is discharged via the condensate collection container. Thereby no condensate can reach the base or the floor of the vacuum cooling device. Thereby a hygienic operation of the complete vacuum cooling process, the charging and discharging of the vacuum chamber can be guaranteed. The accessibility can be increased additionally for cleaning purposes if the vacuum chamber is arranged on feet. A free space remains between the floor and the vacuum chamber. The floor below the vacuum chamber is accessible and can be cleaned easily. If the vacuum chamber is arranged on feet an automated charging and discharging system can be used.

A configuration comprising one or two doors can comprise two or more vacuum chambers which are arranged next to each other. For example in one of the vacuum chambers a vacuum cooling process can run whereas the other vacuum chamber is discharged and subsequently charged. As soon as the vacuum cooling process is finished the sliding door is opened and the neighboring vacuum chamber is closed whereby the vacuum cooling process can be performed immediately thereafter. That means each of the two vacuum chambers are either charged or discharged or are used for performing a vacuum process. Herewith the bakery products to be subjected to a vacuum cooling process can be supplied continuously. A packaging plant arranged downstream of the vacuum cooling device can be supplied continuously with the vacuum cooled bakery products.

The condensate trickling down the sliding door is collected in a collection container which is cleaned sporadically automatically. Hereby a source of contamination is eliminated which may lead to the formation of undesired germs. This can have the consequence that a hygienic operation mode is maintained with refused cleaning requirement. The safety for personnel is substantially enhanced as it is avoided that liquid reaches the floor and the slip danger is thereby reduced.

The method for operation of the sliding door for the vacuum cooling device comprises the following steps: operation of an opening and closing mechanism whereby by operating the opening and closing mechanism for closing the vacuum chamber of the vacuum cooling device a door leaf of the sliding door is pressed against a door flange of frame whereby in the second step the seal between the door leaf and the door flange is pressed such that the vacuum chamber is closed fluid tightly whereby a gentle vacuum cooling of the foodstuff is performed by the slow decrease of pressure.

In particular the sliding door can be opened manually whereby the sliding door comprises a drive for its movement which can be decoupled from the sliding door to open the opening and closing mechanism of the sliding door at the same time.

In the following embodiments of the invention are explained with reference to the drawings. Thereby it is shown in:

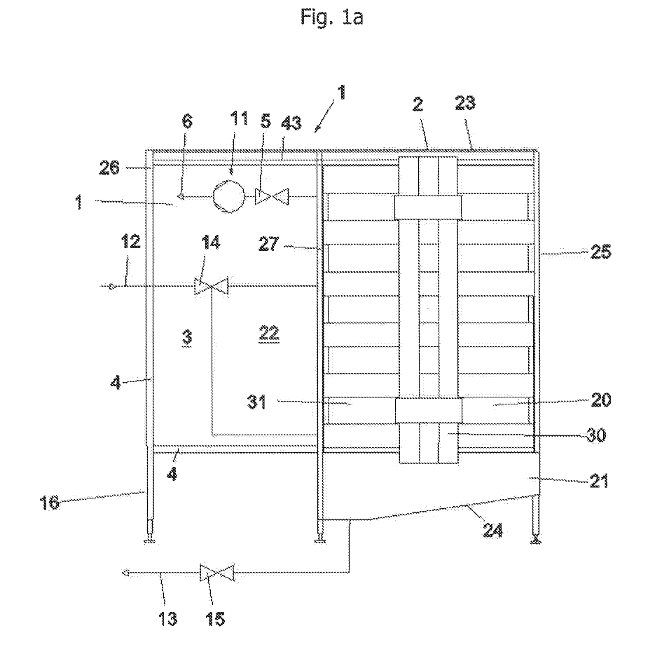

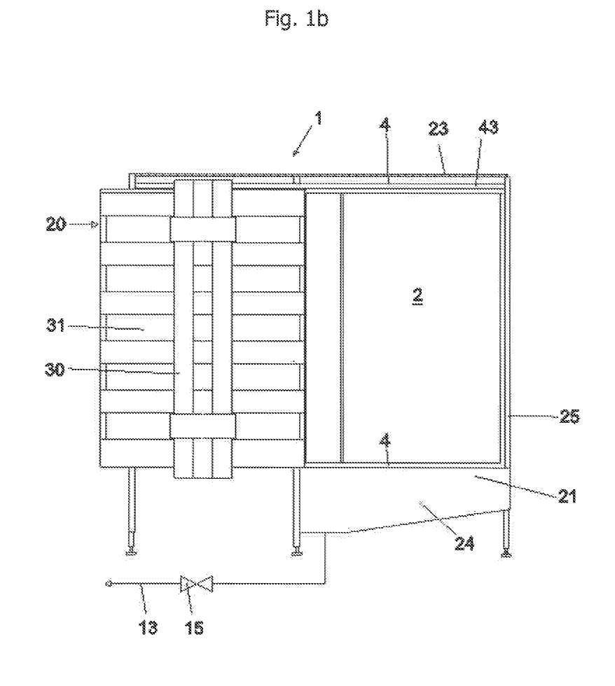

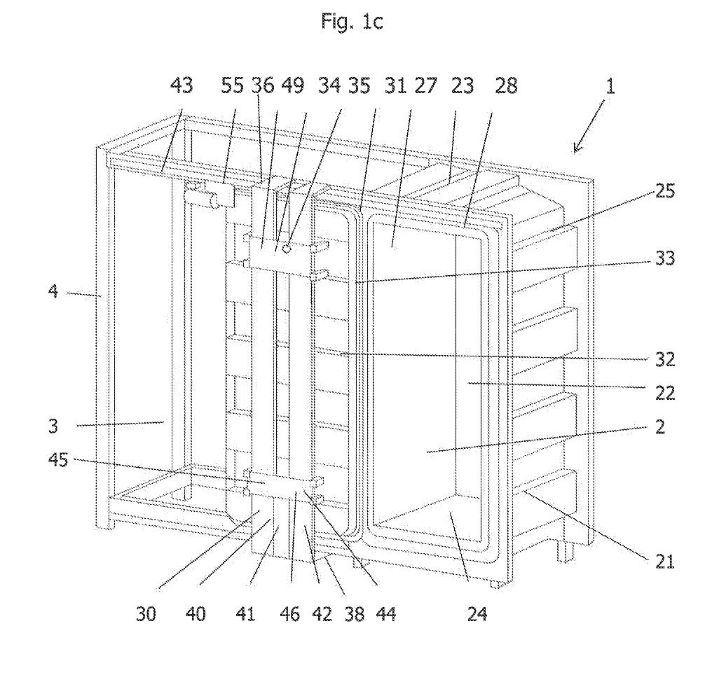

FIG. 1a a view of a vacuum cooling device in the closed state,

FIG. 1b a view of the vacuum cooling device in the open state,

FIG. 1c a view of the vacuum cooling device in perspective in the open state,

FIG. 1d a view of the vacuum cooling device in perspective in the closed state,

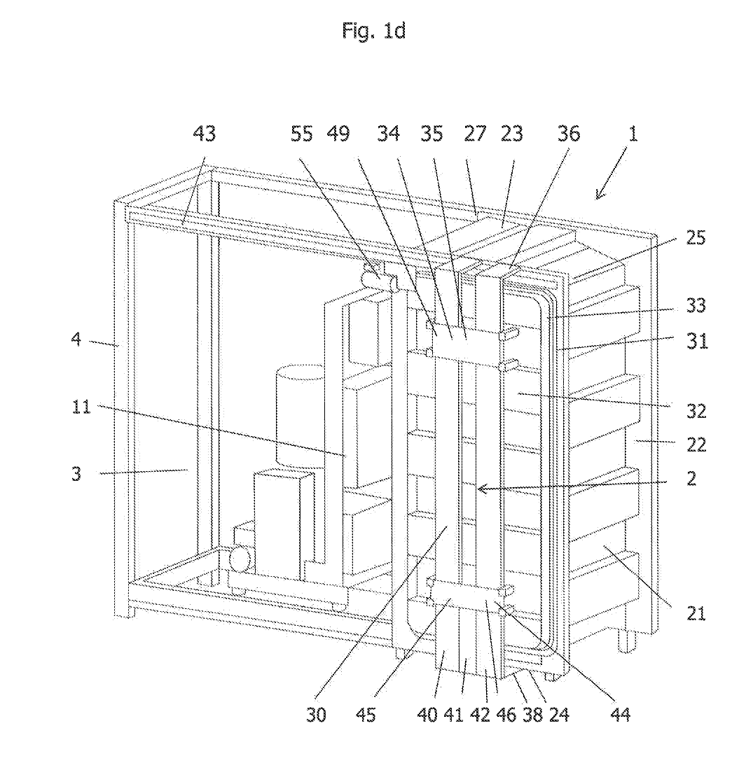

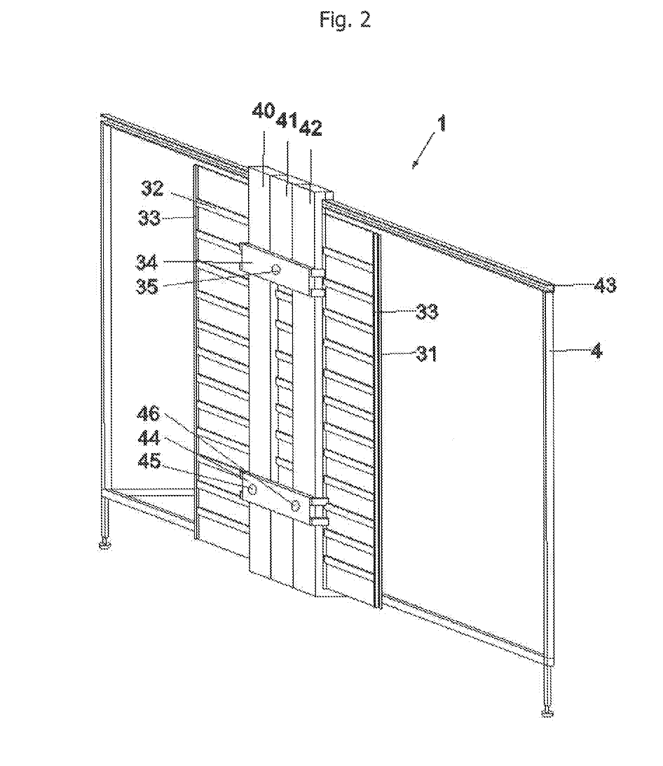

FIG. 2 a view of a vacuum cooling device according to a second embodiment,

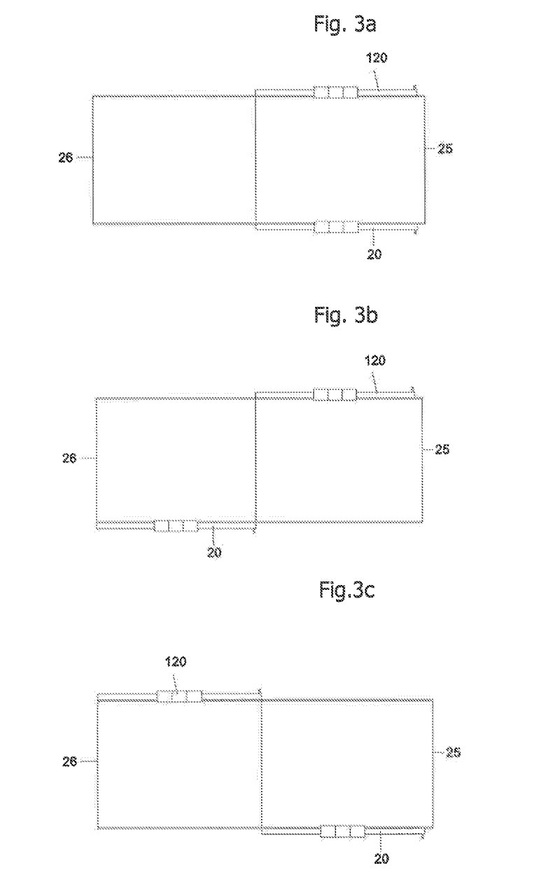

FIG. 3a a view of a vacuum cooling device according to a third embodiment in the closed state in a view from above,

FIG. 3b a view of the vacuum cooling device according to the third embodiment in the open state in a view from above for charging with foodstuff,

FIG. 3c a view of the vacuum cooling device according to the third embodiment in the open state in a view from above for discharging of foodstuff,

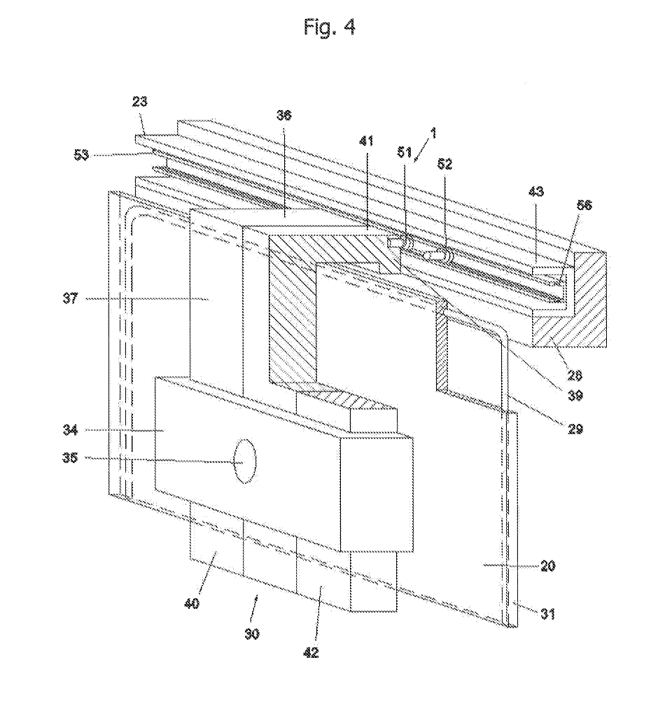

FIG. 4 a detail of FIG. 2,

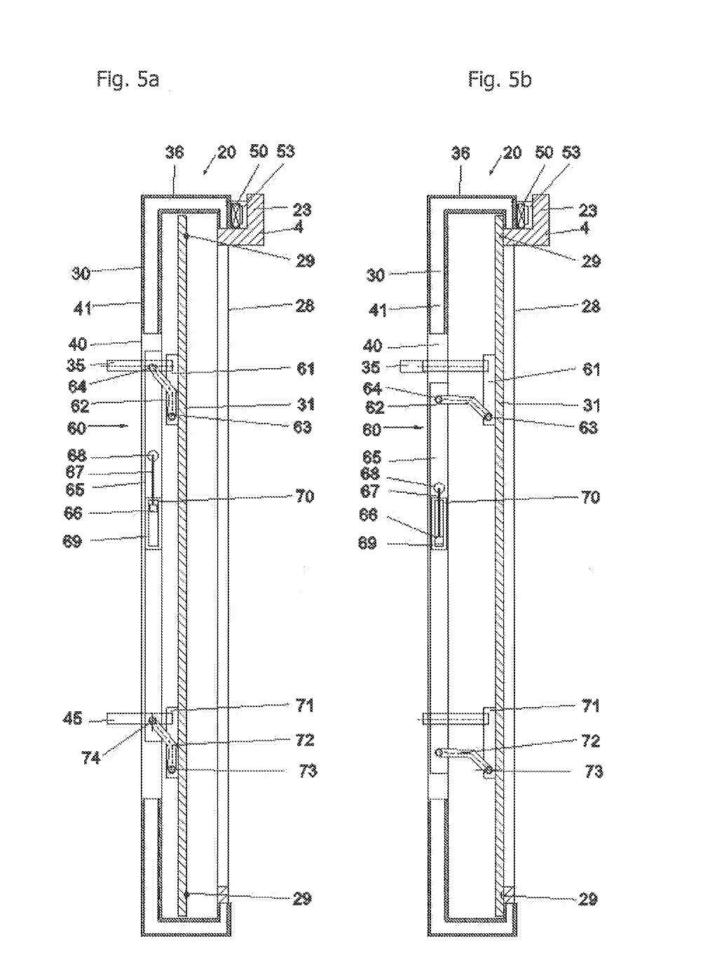

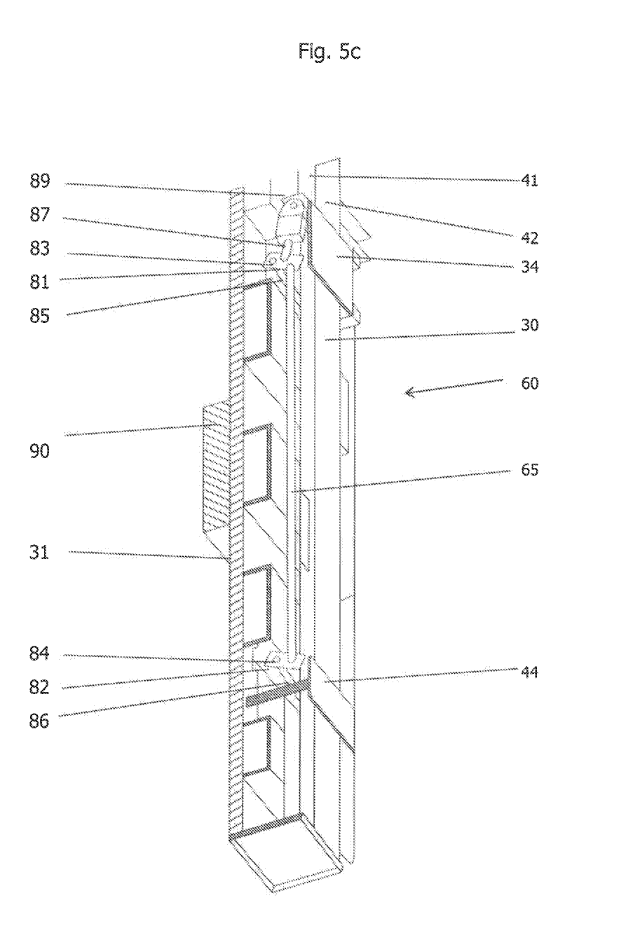

FIG. 5a a detail of the opening and closing mechanism in the open state,

FIG. 5b the opening and closing mechanism of FIG. 5b in the closed state,

FIG. 5c a detail of a variant of an opening and closing mechanism,

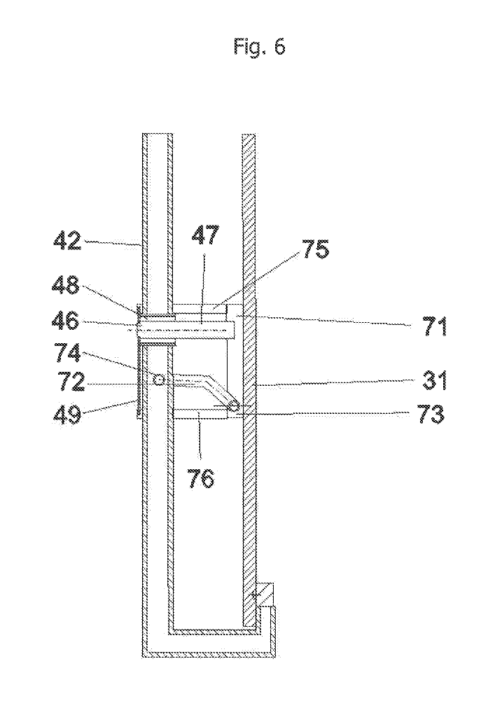

FIG. 6 an embodiment for a compensation element,

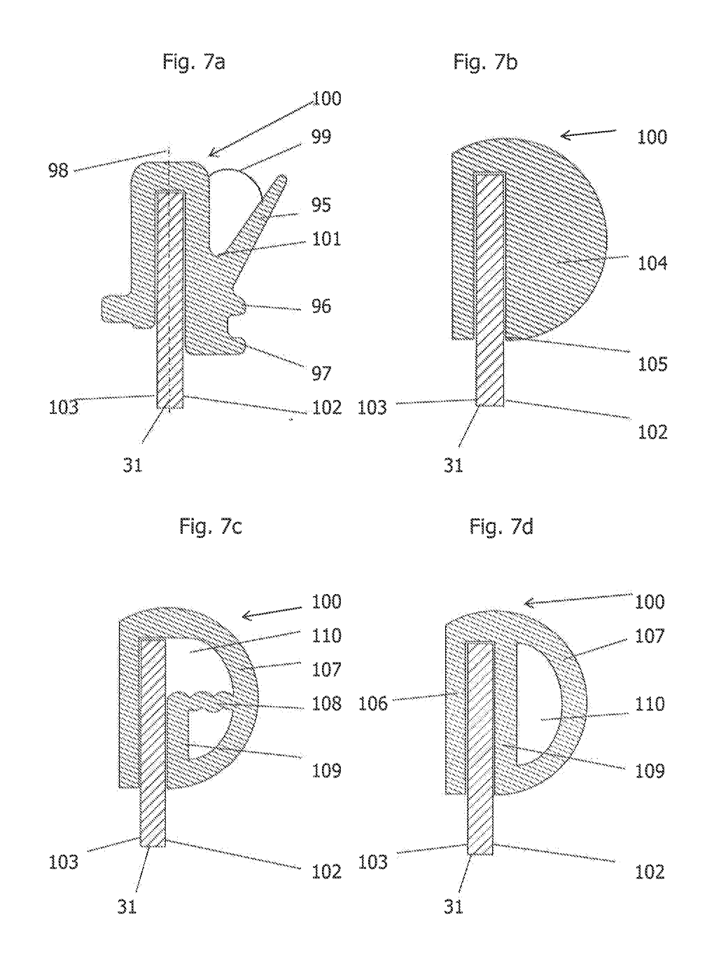

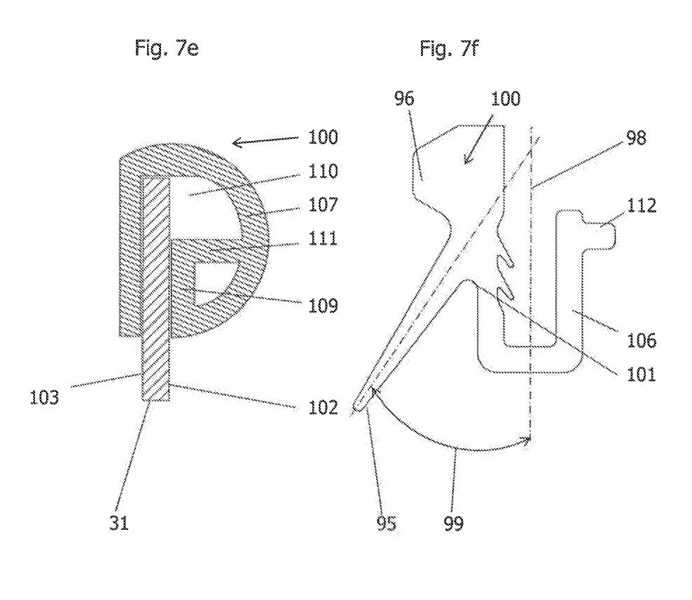

FIG. 7a a first variant for a door seal,

FIG. 7b a second variant for a door seal,

FIG. 7c a third variant a door seal,

FIG. 7d a fourth variant for a door seal,

FIG. 7e a fifth variant for a door seal,

FIG. 7f a sixth variant for a door seal,

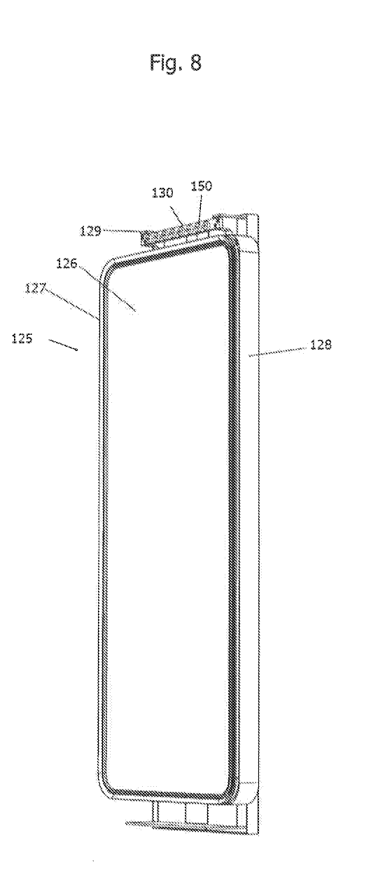

FIG. 8 an inner view of the sliding door for a vacuum cooling device according to a fourth embodiment.

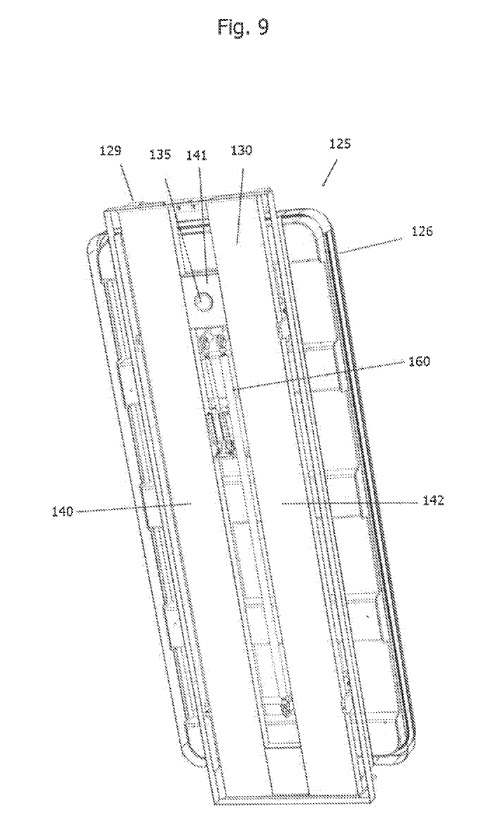

FIG. 9 an outer view of the sliding door according to FIG. 8,

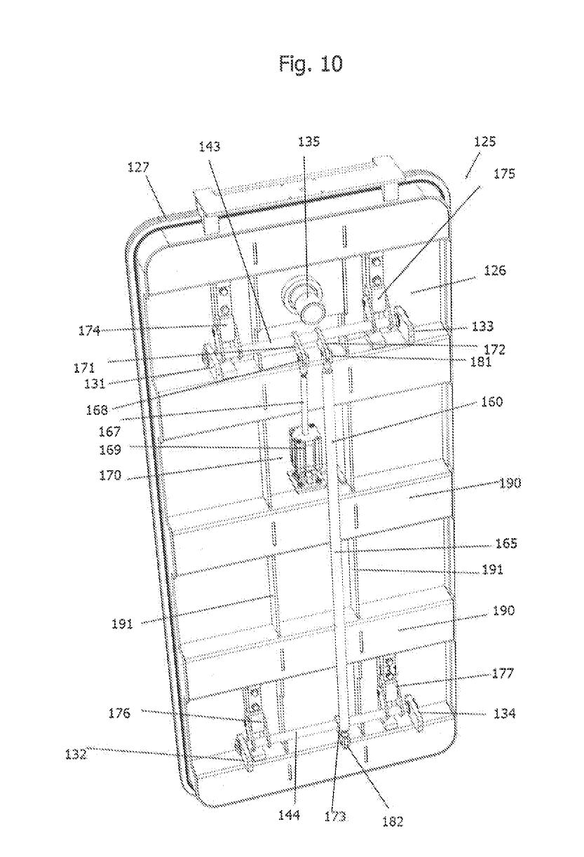

FIG. 10 a detail of the sliding door according to FIG. 8,

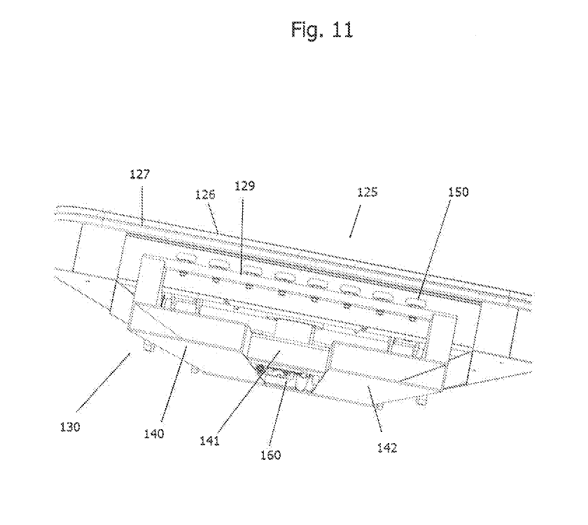

FIG. 11 a further detail of the sliding door according to FIG. 8.

The vacuum cooling device 1 shown in FIG. 1a comprises a vacuum chamber 2 as well as chamber 3, in which are arranged a device for generating a vacuum for example a vacuum pump 11, supply and discharge conduits of process fluids 6 as well as devices for generation, transformation or regeneration of energy, in particular heat. The vacuum pump 11 is connected to the vacuum chamber 2 by a vacuum conduit 6 if the valve is opened. For evacuation of the inner space of the vacuum chamber 2 the vacuum pump 11 is driven by the drive motor not shown which removes the gas in particular the air from the vacuum chamber until a defined sub-atmospheric pressure is reached.

The vacuum chamber has a floor 24 and a ceiling 23. A first side wall 25 and a second side wall 26 extend between the floor 24 and the ceiling 23. All walls can be suspended in the frame 4, which is shown schematically by a carrier pertaining to the frame. An intermediate wall 27 is arranged between the first side wall 25 and the second side wall 26 to separate the vacuum chamber 2 from the chamber 3. The rear wall 22 visible in FIG. 1a in the chamber 3 is delimited by the floor 24, the ceiling 23, the first side wall 25 and the second side wall 26. A front wall 21 is arranged opposite the rear wall 22. The front wall 21 is delimited by the floor 24, the ceiling 23, the first side wall 25 and intermediate wall 27. The front wall 21, the rear wall 22, the first side wall 25, the second side wall 26 as well as the intermediate wall 27 extend substantially in vertical direction between the floor 23 and the ceiling 24.

The door 20 is arranged in the wall 21. The door 20 is a sliding door which is opened to place the foodstuff inside the vacuum chamber and to discharge it from the vacuum chamber after completion of the vacuum cooling. If the sliding door 20 is closed a vacuum can be generated in the vacuum chamber. The chamber 3 can be open on the front side shown in FIG. 1a, such that the device for generating the vacuum, for example the vacuum pump, supply and discharge conduits of process fluids as well as devices for generation, transformation or regeneration of energy, in particular heat is possible anytime. The front wall 21 can also dose the chamber 3 to protect the chamber from contamination or for noise protection to reduce the noise generated by the vacuum pump or the drive unit thereof. The chamber 3 can be accessible also by a door however this door is not displayed in the graphic representation for the reason of simplicity.

An embodiment shown the vacuum chamber 2 is the limited by the wall 21, the sliding door 20, the opposite rear wall 22, the first wall 25 and the intermediate wall 27, the ceiling 23 as well as the floor 24. Thus the walls, the floor and the ceiling form the boundary elements of the vacuum chamber 2. Each of the boundary elements is supported by the frame 4. The walls and the ceilings can contain stiffening elements which can be configured as ribs, as reinforcing elements, as carriers, as a structure in the surface of the boundary element. Such stiffening elements are omitted in the graphical representation for reasons of simplicity. These stiffening elements are foreseen to prevent a deformation of the boundary elements in case of a vacuum being applied to the vacuum chamber 2, such that the stiffening elements retain their shape and thereby the volume of the vacuum chamber remains substantially constant,

The wall 21, the opposite rear wall 22, the first side wall 25 as well as the second side wall 26, the ceiling 23 as well as the floor 24 can be retained in a frame 4. The frame 4 is represented in FIG. 1a or FIG. 1b by a carrier.

The sliding door 20 is shown in FIG. 1 in the closed state that means the vacuum chamber is closed by the sliding door. The sliding door 20 replaces a portion of the wall 21, such that after opening the sliding door the access to the interior of the vacuum chamber is free. The door has to close a corresponding large opening such that the charge and discharge of the vacuum chamber can be completed rapidly. Ideally the bakery products which are arranged on the rack are charged into the vacuum chamber together with the rack and remain on this rack during the complete vacuum cooling process. After completion of the vacuum cooling process the vacuum cooled bakery products are removed together with the racks and can be subjected to further processing steps which can comprise a cooling as well as a packaging of the goods.

The sliding door 20 is according to FIG. 1a or FIG. 1b held by a holding element 30 in at least one carrier 43 of the frame 4 and can be displaced along with the carrier 43. FIG. 1 a shows the sliding door 20 in the closed position, FIG. 1b shows the sliding door in the open position. In FIG. 1c the door flange 28 as well as a portion of interior of the vacuum chamber is visible.

A seal is arranged between the sliding door 20 and the wall 21, such that a fluid tight seal of the vacuum chamber from the surroundings is obtained, if the sliding door is closed. The seal can be configured as a circumferential seal which runs inside the door flange 28 or is attached to the inner side of the sliding door 20. In particular the circumferential seal may be arranged in a groove in the door flange 28. The seal can be assembled and dismounted in a simple manner to be exchanged or cleaned. For example the seal can be submerged temporarily in a cleaning solution. After completion of the cleaning step, the seal can be mounted again in the door flange, on the inner side of the sliding door or around the circumference of the door leaf.

FIG. 1c shows a view of the vacuum cooling device in perspective representation in the open state. The vacuum cooling device 1 contains the vacuum chamber 2 and chamber 3. A frame 4 is used for receiving the walls of the vacuum chamber as well as the drives necessary for the operation of the vacuum chamber, vacuum generators as well as steering and control elements. As in FIG. 1a the vacuum chamber comprises the ceiling 23, a floor 24, a first side wall 25 as well as a second side wall 27. The rear wall 22 can also be configured as a door. The front side of the vacuum chamber to is closable by a sliding door 20. The sliding door 20 consists of a door leaf 31, which can be reinforced by a plurality of reinforcing elements. For instance a plurality of cross beams 32 can be foreseen, which can extend to vertically arranged longitudinal beams, which are arranged close to the edge of the door leaf 31. The sliding door 20 is held by a holding element 30 in the frame construction 4. A guiding rail 43 is arranged in the frame along which the sliding door can be moved from the open position to the closed position. The holding element is collected to a drive 55, which can guide the sliding door automatically in response to received control signals of a control unit containing a control algorithm or as assistance to a manual movement from the open position into the dosed position and vice versa. In the closed position of the sliding door the vacuum chamber is closed and the vacuum can be applied. This position is shown in FIG. 1d. The holding element consists of a first carrier 40, a second carrier 41 and a third carrier 42. These carriers are connected to the door leaf 31 by a first compensation element 35 and a second compensation element 45. This connection is obtained by a first clamping element 34 and a second clamping element 44. The clamping element forms a connection between the door leaf and the holding element, whereby the door leaf 31 is movable relatively to the holding element 30.

FIG. 1d shows the view of the vacuum cooling device according to FIG. 1c in perspective representation in the closed state.

FIG. 2 shows a view of the sliding door of the vacuum cooling device 1 in a view omitting the vacuum chamber. That means this figure only shows the front side of FIG. 1. It differs from the representation according to FIG. 1a and FIG. 1b only inasmuch as the holding element 30 for the sliding door is configured in three portions. Accordingly its not shown that the walls 25, 26, 27, the floor 24 and the ceiling 23 are contained in the frame 4.

The sliding door 20 comprises a door leaf 31, which is reinforced by two longitudinal beams 33 as well as a plurality of cross beams 32 as a difference to the preceding embodiments. The holding element establishes the connection to the frame and holds the sliding door in the frame 4. A guiding rail 43 is foreseen for moving the holding element 30 and the door leaf 31 in horizontal direction forth and back. The holding element 30 consists of three carriers 40, 41, 42, which are held by a clamping element 34 and clamping element 44. The clamping element 34 contains the first compensation element 35, the clamping element 44 contains a second compensation element 45 and a third compensation element 46. One of the compensation elements is shown in detail in FIG. 6.

FIGS. 3a to 3c show a top view of a further possible embodiment for a vacuum cooling device 1, which is closable by a plurality of sliding doors 20, 120.

FIG. 3a shows a view of the vacuum cooling device in the closed state. In FIG. 3a a second door 120 is shown in addition to the sliding door 20, which is arranged on the opposite side of the vacuum chamber. The sliding door 20 and the door 120 can be closed or opened alternatively such that the vacuum chamber can assume a gating function. The foodstuff to be cooled is introduced for example into the vacuum chamber when the sliding door 20 is open. The door 120 is closed. In this embodiment the door 120 is also configured as a sliding door however it could be also configured as a pivotable door what is not shown in the drawings.

FIG. 3b shows a view of the vacuum cooling device 1 according to FIG. 3a in the open state in a view from above for charging with foodstuff. As soon as the charging is completed the sliding door 20 is closed. Then a vacuum is applied to the vacuum chamber. As soon as the vacuum cooling is completed the door 120 is opened.

FIG. 3c shows a view of the vacuum cooling device 1 according to FIG. 3a in the open state in a view from above for discharging with foodstuff. The door 120 is also configured as a sliding door in this embodiment.

FIG. 4 shows a partial inner view of the sliding door 20. The sliding door can be configured according to any one of the embodiments of FIG. 1a, FIG. 1b, FIG. 2, FIG. 3a, FIG. 3b or FIG. 3c. The sliding door 20 is held by a holding element 30 in a guiding rail 53. The guiding rail is contained in the guiding rail 43, along which at least one upper limb 36 of the holding element 30 slides and is guided. The holding element 30 is configured in three portions as shown in FIG. 2. It consists of three similar carriers 40, 41, 42 which are assembled by a clamping element 34. One of the carriers 40 is shown completely, but the two carriers arranged in front of the carrier element shown in FIG. 4 are cut so to allow a view onto the guiding rail 53 and the rollers 51, 52 guided therein. The carrier 40 contains a further roller which is not shown in the drawings. The holding element 30 is substantially C-shaped. It comprises an upper limb 36, a basis 37 and a lower limb 38 which is not shown in this figure but in FIG. 1c, The limb 36 engages at least partially into the guiding rail 53 on its vacuum chamber sided end. A roller 51 is attached to the end 39 of the upper limb 36. The roller 50 slides in the guide rail 53 which is attached to the inner wall of the guide rail 43. Two further rollers are foreseen which belong to the carriers 40, 42 and are connected in the same manner to the limbs by their ends. The sliding door 20 can be moved by these rollers along the guiding rail 53.

The guiding rail 53 can obtain a guiding element 56 which keeps the rollers on their track. This guiding element 56 can be configured for instance as a groove. The rollers 51, 52 are prevented from sliding into a direction normally to the translation direction of the sliding door 20 by the groove.

The sliding door 20 moves thus during opening together the carrier 40, 41, 42 until the first stop, which is arranged at the end of the guiding rail 53 and is not shown. Then the sliding door moves during closing to the second stop, which is arranged on the opposite end of the guiding rail 53. Consequently the door is always at least partially supported by the rollers 50, 51, 52 on the guiding rail 53. Thereby the weight of the sliding door 20 is transferred by the rollers onto the guiding rail 53 and then from the guiding rail 53 onto the guiding rail 43. The guiding rail 43 can be part of the frame 4.

Only a portion of the door leaf 31 is shown from the sliding door 20. The upper right corner is shown in section to show a portion of the seal 29 which is arranged in the door leaf. The seal 29 is configured as a circumferential seal. The seal 29 runs in a groove of the door leaf 31. Alternatively the seal could be arranged also in the door flange 28 which is not shown in the drawing. In the closed state the seal 29 is supported by the door flange 28.

The sliding door is movable by a closing and opening mechanism—which is not shown—between a sealed state and a state in which an opening and closing of the sliding door is possible. By means of the closing mechanism the sliding door 20 can be moved into the direction of the interior of the vacuum chamber 2 if it is in the closed position. The seal 29 is subjected to a pressure such that it seals the door leaf 31 against the door flange 28.

If the sliding door is to be moved an opening mechanism is actuated. In this position the seal 29 is unloaded and there is also the possibility to set the distance between the seal and the door leaf to allow for a free movement of the sliding door without touch. According to this variant the seal has a distance to the door leaf 31 such that the seal is not under load during movement. Only if the door is about to be closed the sliding door is moved against the door flange by the closing mechanism such that the seal 29 is supported on the door flange 28.

FIG. 5a and FIG. 5b show an example for closing and opening mechanism for a sliding door 20 according to any of the preceding embodiments. The sliding door is shown in a section which shows the door leaf 31 as well as the holding element 30 in a cut section. FIG. 5a shows the open state, FIG. 5b shows the closed state of the sliding door 20. In the open state the door leaf 31 has a distance to the door flange 28. A portion of the frame 4 belonging to the ceiling 23 of the vacuum chamber 1 is shown in section. The frame has in this graphic representation a L-shaped cross section. The L forms a support surface on which a guiding rail 53 is arranged, in which at least one roller 50 is contained. The roller is connected to the limb 36 of the holding element 30.

The holding element 30 can be displaced by the movement of the rollers in the guiding rail 53 in horizontal direction (viewed from the plane of the drawing). The holding element 30 carries the door leaf 31. The carrying function is performed by the compensation elements 35, 45, 46. The compensation element 35 is attached to a composition 61 of the door leaf 31. A bore can be arranged in this composition which contains the bolt shaped compensation element. The compensation element 45 is this connected fixedly to the door leaf. The compensation element passes through a bore in the holding element and protrudes from the bore at the variable length depending on the position of the sliding door. The compensation element equalizes thus the different distances between the holding element and the door leaf in the open and closed state of the sliding door. The difference between open and closed state is shown in an exaggerated manner. Commonly the difference is only a few millimeters such that the seal 29 is not anymore in contact with the door flange 28 to open the sliding door. As soon as the seal is free no shear forces can act on to the seal anymore, therefore the seal is substantially not subject to shear forces during the displacement process. As a consequence the lifetime off the seal can be increased from a couple of days to some years.

The opening and closing mechanism 60 comprises a lever element 62 attached to the composition 61. The lever element 62 is rotatably connected to transmission element 65. The pivot 63 forms the connection of the lever element 62 of the door leaf with the composition 61. The pivot 64 forms the connection of the holding element of the lever element 62 with the transmission element 65. The transmission element 65 is actuated by a drive element 70. In this embodiment the drive element 70 is configured as a fluid actuated cylinder 69 in which a piston 66 is movable. The growth element is connected fixedly to the carrier 42 however it is positioned in front of the cutting plane and therefore it is not visible in this section. The piston is disposed with a piston rod 67 which is connected to the transmission element 65 by a fastening element 68. A second composition 71 is foreseen to which is attached a second pivotably connected lever element 72. The lever element 72 is connected pivotably to the transmission element 65. The pivot 74 forms the connection of the holding element of the lever element 72 with the transmission element 65.

FIG. 5c shows a detail of an opening and closing mechanism 60 according to a variant. For this reason the door 20 is cut in vertical direction along the holding element 30. The carrier 42 is visible, the carrier 40 would lie in front of the plane of drawing and is thus invisible and the carrier 41 is removed for simplicity of the representation. The clamping element 34 and clamping element 44 shown partially in section. The opening and closing mechanism comprises the transmission element 65 which extends between an upper first hinge 81 and a lower second hinge 82. Each of the hinges is connected by a connection element 83, 84 with the reinforcing element 85, 86 attached to the door leaf 31 or the cross beam 32. The first hinge 81 is connected to a fluid actuated cylinder 89. The fluid actuated cylinder 89 is connected at one end fixedly to the holding element 30 on the other end it is connected to the hinge 81. If the fluid actuated cylinder is actuated that means the piston is displaced together with its piston rod 87 downwardly then the hinge 81 moves downwardly. The hinge 81 is connected to the hinge 82 by the transmission element 65 which performs a similar movement. By moving the hinge the door is moved into the direction of the holding element. That means the door lifts off from the door flange whereby the vacuum chamber is opened. The seal is distant from the door flange that no shearing forces occur during the movement of the door from the closed position into the open position.

Furthermore a bar like reinforcing element 90 is shown in FIG. 5c which is attached to the inner side of the door. The reinforcing element is used to reinforce the door against forces which result from the application of the vacuum. Due to the fact that the door has a large planar surface which is subjected to sub-atmospheric pressure in the vacuum chamber, the door is subjected to bending forces. These bending forces increase the more the surface points of the door surface are distant from the fixation that is the door flange.

FIG. 6 shows a detail of one of the compensation elements. In this embodiment only the compensation element 46 is shown however the compensation elements 35, 45 can be configured in the same manner. The compensation element consists of a bolt shaped element body 47 and a connection element 48, which is arranged around the element body 47. The element body 47 and the connection element are fitted into an opening of the carrier 42 and a further opening of the composition 71 of the door leaf 31. The element body is connected to an outer plate element 49 which is part of the clamping element 44. The connection element 48 is connected slidingly with the element body 47 and extends to the plate element 49. The plate element is connected to the composition 71 by an upper and a lower holding element 75, 76.

The current arrangement has the advantage that the opening and closing mechanism is not in contact with the vacuum area, It is also possible to arrange the vacuum chamber 2 on the left side of the representation according to FIG. 2.

It will also be possible to replace the rollers by spheres whereby a suitable holding device for the spheres has to be foreseen.

FIG. 7a shows a first variant for a door seal 100 which is arranged around an edge of the door leaf 31. The door seal has a first lip 95, a second lip 96 and a third lip 97. The first lip 95 is arranged in an acute angle alpha 99 with respect to the vertical axis 98 running through the door leaf in this graphical representation. The acute angle 29 is measured from the edge of the door leaf 31. The first lip 95 is positioned on the door flange if the door is closed and is deformed correspondingly. In addition the pressure of the surroundings is present in the groove 101 which presses the first lip 95 additionally against the door flange if the vacuum is applied.

FIG. 7b shows a view of a second variant for a door seal. This door seal is also arranged around the edge of the door leaf 31. On the inner side 102 of the door leaf 31 a protrusion 104 is arranged which is made from an elastic material. This protrusion is pressed against the door flange in operation. The protrusion contains a circumferential groove 105 which is put over the edge of the door leaf 31. Advantageously the inner diameter of the groove 105 is smaller than the thickness of the door leaf 31 i.e. the normal distance from its inner side 102 to its outer side 103. The limb 106 of the door seal which extends along the outside 103 of the door leaf can have a constant thickness.

FIG. 7c shows a view of a third variant for a door seal 100 which has protrusion 107 which is not closed completely. This door seal is easy to assemble due to the fact that the friction resistance is decreased as it is not supported along the entire depth of the groove 100 on the edge of the door leaf. This door seal has on the outer side 103 also a limb 106. The protrusion 107 has also hollow space 110. The hollow space contains a spring element which is arranged here as an elastic connection element 108 between the inner limb 109 and the arc shaped body of the protrusion 107 in the hollow space 110.

FIG. 7d shows the fourth variant for a door seal 100 which differs from the preceding variant according to FIG. 7c in that the hollow space 110 is closed. Thereby no contaminants can reach the hollow space and the seal can fulfill highest hygienic standards. The arc shaped protrusion 107 is on both ends connected to the inner limb 109 of the seal which is supported on the inner side 102 of the door leaf 31.

FIG. 7e shows a fifth variant for a door seal 100 which is configured similarly to the door seal according to FIG. 7c. The only difference is that the connection element 111 is not formed as a spring element. The connection element 111 can consist of an elastic material such that it is compressible during the vacuum operation.

FIG. 7f shows a sixth variant for a door seal 100 which has a similar configuration as the door seal according to FIG. 7a which is arranged around an edge of the door leaf 31. This seal has a substantially U-shaped seal body configuration. The inner limb of the u-shaped seal body serves to receive the door leaf which is omitted in this drawing for simplicity. The door seal has a first lip 95 as well as a second lip 96 which rest on the door flange when the sliding door is closed. The first lip 95 is arranged in an acute angle alpha 99 with respect to the vertical axis 98 running through the door leaf in this graphical representation. The first lip 95 is positioned on the door flange if the door is closed and is deformed correspondingly. In addition the pressure of the surroundings is present in the groove 101 which presses the first lip 95 additionally against the door flange if a vacuum is applied. Further lips can be arranged at least on the inner wall of the limb of the u-shaped seal body. In the graphical representation of FIG. 7f two such lips are shown. The seal body is pressed against the door leaf by means of these lips and remains attached to the inner wall even if the elasticity of the seal material decreases over time. A protrusion 112 can be foreseen for purposes of assembly or disassembly of the seal on the limb 106.

FIG. 8 shows an inner view of the sliding door 125 for a vacuum cooling device according to a fourth embodiment. The sliding door 125 has a door leaf 126 which contains a circumferential seal 127 which runs along the edges of the door leaf 126. In this graphical representation the door leaf 126 covers the reinforcing construction laying behind such that the elements carrying of the door leaf are not visible. The carrying elements are arranged below the cover 128 which is arranged of the outer side of the door leaf. The cover can be configured as a single part or can consist of multiple parts. The door is collected by an upper limb 129 of a holding element 130 with a door flange which is configured in a similar shape as the door leaf 28 in FIG. 4 and is not shown in this drawing.

FIG. 9 shows an outer view of the sliding door according to FIG. 8 whereby the cover 129 is removed to show the details of an opening and closing mechanism 160 for the door leaf 125. The holding element 130 can thus be moved by the movement off the rollers in the guiding rail in horizontal direction (here out from the plane of drawing). The holding element 130 carries the door leaf 126. The carrying function is performed by the compensation element 135. The compensation element 135 is arranged in an installation of the door leaf 126 which is covered in this view by a carrier 141. In the current embodiment the carrier 141 is configured as a connection element which connects the carrier 140 with the carrier 142. A bore is arranged in the installation and in the carrier 141 which receives the bolt shaped compensation element 135. The compensation element 135 is this connected fixedly with the door leaf 126. The compensation element 135 runs through a bore in the carrier 141 and protrudes depending on the position of the sliding door from the bore over a variable length. The compensation element thus compensates the differing distances between the holding element and the door leaf in the opened or closed position of the sliding door. The translation can make up only a few millimeters as it is sufficient that the seal 127 is not anymore in contact with the door flange to open the sliding door. As soon as the seal is free no shear forces can act upon the seal such that the seal is not subjected to shear forces during the translational movement. Thereby the life span of the seal can be increased from a couple of days to a couple of years.

The opening and closing mechanism 160 is shown in detail in FIG. 10. In FIG. 10 the carriers 140, 141, 142 are removed to allow for viewing the opening and closing mechanism. An arm 131 and an arm 132 are arranged on the carrier 140. An arm 133 and an arm 134 are arranged on the carrier 142. A connecting bar 143 extends from of the arm 131 until the arm 133. Both of the ends of the connecting bar 143 are received in bores of the arms 131, 133. The connecting bar 143 has a middle axis which extends substantially in horizontal direction if the sliding door is assembled. The sliding door is connected by hinges 174, 175 with the connecting bar 143. The sliding door is connected by hinges 176, 177 with the connecting bar 144. The connecting bar 144 extends from the arm 132 two the arm 134. Both of the ends of the connecting bar 144 are received in bores of the arms 132, 134. The connecting bar 144 has a middle axis which extends substantially in horizontal direction if the sliding door is assembled. A connecting bar 165 connects both of connecting bars 143 and 144. A drive element 170 in the shape of a fluid actuated cylinder 169 is connected to the connecting bar 143. The fluid actuated cylinder comprises a piston rod 167 which can be moved forth and back by a piston arranged in the interior of the fluid actuated cylinder 169. The free end of the piston rod is configured as a hinge element 168 which is connected to a hinge arm 171 which is attached to the connecting bar 143. A second hinge arm 172 is arranged on the connecting bar 143. This hinge arm 172 is connected rotatably by a first hinge element 181 to the connecting bar 165. The connecting rod is connected by second hinge element 182 with the connecting bar 144. A hinge arm 173 is extends between the hinge element 182 and the connecting bar 144.

If the fluid actuated cylinder 169 is operated that means the piston and the piston rod 167 are moved downwardly the hinge element 168 moves downwardly. The connecting bar 143 is moved by the hinge element 171 about its horizontal axes and thereby the hinge element 174 and 175 as well as the hinge arm 172 and the hinge element 181 which moves the connecting bar 165. The connecting bar 165 initializes a downward movement of the hinge element 182 as well as the hinge arm 173. The hinge arm 173 is connected to the connecting bar 144 which is rotated also about its horizontal axis such that the hinge elements 176 and 177 are operated. The door leaf 126 of the sliding door 125 is thereby moved away from the door flange to open the vacuum chamber. The sliding door 125 can thereby moved to liberate the inlet into the vacuum chamber to discharge or charge it with bakery products. If the vacuum chamber is to be closed the piston rod 167 is moved upwardly.

And FIG. 10 also a plurality of bar shaped reinforcing elements 190 is shown which are arranged on to side of the door leaf 126. These reinforcing elements are used to reinforce of the door leaf against forces which come into existence as a consequence of applying the vacuum. Due to the fact that the door leaf has a large planar surface which is subjected to a subatmospheric pressure when operating the vacuum chamber bending forces act on the door leaf. These bending forces increase the further the surface points of the door surface are distant from the support that means from the door flange. In addition to the bar shaped reinforcing elements 190 also baffles 191 can be foreseen which run cross wise to the reinforcing elements 190.

FIG. 11 shows the sliding door 125 in the view from above. The frame is executed as shown in FIG. 5a or FIG. 5b. A guiding rail is arranged in the frame in which at least one roller 150 is received. The roller is connected by its upper limb 129 to the holding element 130 and is supported therein rotatably.

1. A vacuum cooling device for cooling of foodstuff in particular hot bakery products comprising a vacuum chamber which is configured for receiving the foodstuff for its cooling, whereby the vacuum chamber is closeable by a sliding door, whereby the sliding door is movable substantially in horizontal direction and the sliding door or the door flange contains a seal, which enables a fluid tight sealing in the closed state of of the door of the vacuum chamber against the surroundings.

2. The vacuum cooling device according to claim 1, whereby the sliding door rests in the closed state on the door flange.

3. The vacuum cooling device according to claim 1 whereby the seal is configured as a circumferential seal.

4. The vacuum cooling device according to claim 1 whereby the sliding door comprises a carrier whereby the carrier is movably supported in a guide rail.

5. The vacuum cooling device according to claim 4 whereby the carrier comprises rollers which are movable in the guide rail along a horizontal path.

6. The vacuum cooling device according to claim 1 whereby the sliding door comprises an opening and/or closing mechanism.

7. The vacuum cooling device according to claim 6 whereby the sliding door is movable by operating the closing mechanism such that the seal comes to rest upon the door flange whereby a sealing effect is obtainable.

8. The vacuum cooling device according to claim 5 whereby the carrier comprises a compensation element.

9. The vacuum cooling device according to claim 1 whereby a first and a second sliding door are foreseen.

10. The vacuum cooling device according to claim 1 whereby the sliding door comprises a reinforcing element and/or a baffle.

11. The vacuum cooling device according to claim 3 whereby the sliding door comprises a door leaf which rests at least along the seal on the door flange in the closed state.

12. The vacuum cooling device according to claim 11 whereby the seal comprises a compensation element to seal any unevenness in the door leaf and/or the door flange.

13. A method for operating the sliding door for a vacuum cooling device comprising the steps: operating the opening and closing mechanism whereby the sliding door is moved for opening or closing substantially in horizontal direction between an open state and a closed state, whereby by operating the closing and opening mechanism for closing of the vacuum chamber of the vacuum cooling device a door leaf of the sliding door is pressed against a door flange in a frame whereby in a second step a seal between the door leaf and door flange is compressed such that the vacuum chamber is closed fluid-tightly such that the seal allows for a slow pressure decrease for gentle vacuum cooling of foodstuff.

14. The method according to claim 13 whereby the sliding door can be opened manually.

15. The method according to claim 13, whereby the sliding door has a drive for its translational movement which can be decoupled from the sliding door to operate the opening and/or closing mechanism of the sliding door.
